(19) United States
(12) Patent Application Publication
(10) Pub. No.: US 2023/0376339 A1
(43) Pub. Date: Nov. 23, 2023

(54) METHODS AND APPARATUS FOR MANAGING TASK TIMEOUTS WITHIN DISTRIBUTED COMPUTING NETWORKS

(71) Applicant: Walmart Apollo, LLC, Bentonville, AR (US)

(72) Inventor: Aditya Ajay Athalye, Bangalore, Karnataka (IN)

(21) Appl. No.: 18/317,396

(22) Filed: May 15, 2023

Related U.S. Application Data
(60) Provisional application No. 63/344,313, filed on May 20, 2022.

(51) Int. Cl. G06F 9/455

(52) U.S. Cl. CPC G06F 9/45558; G06F 2009/4557; G06F 2009/45583

(57) ABSTRACT

Systems and methods for managing the timeout of executable task are disclosed. A task is obtained for execution, a timeout associated with a state of the task is determined, and a timeout task is allocated to a slot of a first timing wheel based on the timeout. Each of the slots of the first timing wheel corresponds to an increment of a first period. When the increment corresponding to slot of the first timing wheel expires before an event associated with the state has been received, the timeout task is deallocated from the first timing wheel, a residual time is determined, and the timeout task is allocated to a slot of a second timing wheel based on the residual time. Each of the slots of the second timing wheel correspond to an increment of a second period.

### CROSS-REFERENCE TO RELATED APPLICATIONS

This application claims benefit under 35 U.S.C. 119 to U.S. Provisional Appl. Ser. No. 63/344,313, filed on 20 May 2022, entitled “Methods and Apparatus for Managing Task Timeouts within Distributed Computing Networks,” which is incorporated herein by reference in its entirety.

### TECHNICAL FIELD

The disclosure relates generally to distributed computing technology and, more specifically, to managing the execution of tasks within distributed computing datacenters.

### BACKGROUND

Some datacenters, such as cloud datacenters, may employ multiple servers to handle various data processing tasks. For example, a cloud datacenter may employ hundreds of servers to process large amounts of data. Each server may be associated with a rack of the datacenter, where a rack is a collection of servers. Datacenters may also include data storage capabilities, such as memory devices that allow for the storage of data, and networking resources that allow for communication among and with the servers. In some datacenter examples, servers may execute one or more hypervisors that run one or more virtual machines (VMs). The VMs may be scheduled to execute one or more processing tasks. Execution of the processing tasks may establish one or more state machines, such as finite state machines. For example, a processing task may begin execution at a first state. Upon the detection of one or more events, the processing task may transition to a second state. Some of the time, events required to move a task from one state to another do not happen, or are not detected. In this scenario, the processing task may become stuck in its current state. Some frameworks may allow for a timeout feature where, after a predetermined amount of time, an alert may be provided indicating that the expected events have not occurred. An operator may receive the alert, and investigate the cause of the failure. These issues, however, can have negative impacts on business and customer experience. Moreover, these current solutions tend to be for single machine centric use cases (e.g., HTTP Timeouts, TCP Timeouts, Timeouts while posting to Message Brokers, etc.), and for data in motion use cases (e.g., email applications). Operating over distributed networks may further complicate the issues and further the negative impacts as well.

### SUMMARY

The embodiments described herein are directed to managing the timeout of tasks executed by nodes (e.g., compute hosts, servers) within datacenters, such as cloud datacenters. The embodiments provide a mechanism to handle task state timeouts in a distributed environment by establishing hierarchical timing wheels as described herein that can be replicated across an application cluster. For instance, tasks that are awaiting one or more events to transition states may be allocated to corresponding slots of the hierarchical timing wheels. If the events are detected, or upon a state timeout, the tasks may be deallocated from the corresponding slots of the hierarchical timing wheels. The embodiments can further establish actor engines as described herein that handle updates to the hierarchical timing wheels to allow reliable execution of state timeout actions.

Among other advantages, the embodiments allow for the automatic management of task state timeouts within a distributed computing environment. Moreover, the embodiments establish a reliable and efficient mechanism of handling task state timeouts across various compute nodes distributed within one or more datacenters, thereby reducing negative impacts on business and customer experience. Persons of ordinary skill in the art having the benefit of these disclosures may recognize these and other benefits as well.

In accordance with various embodiments, exemplary systems may be implemented in any suitable hardware or hardware and software, such as in any suitable computing device. For example, in some embodiments, a computing device, such as a cloud-based server, is configured to obtain a task (e.g., a timeout task) for execution. The computing device is configured to execute the task to a first state. Further, the computing device is configured to determine a timeout associated with the first state of the task. The computing device is also configured to determine a slot of a first buffer associated with a first period based on the timeout. The computing device is further configured to allocate the task to the slot of the first buffer.

The computing device is configured to determine that the first period has expired before an event has been received. The computing device is also configured to deallocate the task from the slot of the first buffer. Further, the computing device is configured to determine a residual time based on the timeout and the first period. The computing device is also configured to determine a slot of a second buffer associated with a second period based on the residual time. Further, the computing device is configured to assign the task to the slot of the second buffer.

In some examples, the computing device is configured to determine that the second period has expired before the event has been received. The computing device is further configured to execute the task based on determining that the second period has expired before the event has been received. The computing device is also configured to deallocate the task from the slot of the second buffer.

In some examples, the computing device is configured to determine that the event has been received before the second period has expired. The computing device is also configured to deallocate the task from the slot of the second buffer based on determining that the event has been received before the second period has expired. Further, the computing device is configured to execute the task to a second state.

In some embodiments, a method by at least one processor includes obtaining a task for execution. The method includes executing the task to a first state. Further, the method includes determining a timeout associated with the first state of the task. The method also includes determining a slot of a first buffer associated with a first period based on the timeout. The method further includes allocating the task to the slot of the first buffer.

The method includes determining that the first period has expired before an event has been received. The method also includes deallocating the task from the slot of the first buffer. Further, the method includes determining a residual time based on the timeout and the first period. The method also includes determining a slot of a second buffer associated with a second period based on the residual time. Further, the method includes assigning the task to the slot of the second buffer.

In some examples, the method includes determining that the second period has expired before the event has been received. The method further includes executing the task based on determining that the second period has expired before the event has been received. The method also includes deallocating the task from the slot of the second buffer.

In some examples, the method includes determining that the event has been received before the second period has expired. The method also includes deallocating the task from the slot of the second buffer based on determining that the event has been received before the second period has expired. Further, the method includes executing the task to a second state.

In yet other embodiments, a non-transitory computer readable medium has instructions stored thereon, where the instructions, when executed by at least one processor, cause a computing device to perform operations that include obtaining a task for execution. The operations include executing the task to a first state. Further, the operations include determining a timeout associated with the first state of the task. The operations also include determining a slot of a first buffer associated with a first period based on the timeout. The operations further include allocating the task to the slot of the first buffer.

The operations include determining that the first period has expired before an event has been received. The operations also include deallocating the task from the slot of the first buffer. Further, the operations include determining a residual time based on the timeout and the first period. The operations also include determining a slot of a second buffer associated with a second period based on the residual time. Further, the operations include assigning the task to the slot of the second buffer.

In some examples, the operations include determining that the second period has expired before the event has been received. The operations further include executing the task based on determining that the second period has expired before the event has been received. The operations also include deallocating the task from the slot of the second buffer.

In some examples, the operations include determining that the event has been received before the second period has expired. The operations also include deallocating the task from the slot of the second buffer based on determining that the event has been received before the second period has expired. Further, the operations include executing the task to a second state.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a block diagram of a task management system, in accordance with some embodiments;

FIG. 2 is a block diagram of an exemplary timeout management device, in accordance with some embodiments;

FIG. 3A is a block diagram of an exemplary finite state machine, in accordance with some embodiments;

FIG. 3B illustrates state changes of a node implementing the finite state machine of FIG. 3A, in accordance with some embodiments;

FIG. 4 is a block diagram illustrating hierarchical timing wheels, in accordance with some embodiments;

FIG. 5 is a block diagram illustrating a distributed system with multiple nodes employing hierarchical timing wheels and dedicated actor engines, in accordance with some embodiments;

FIGS. 6A, 6B, 6C, 6D, and 6E are block diagrams illustrating management of hierarchical timing wheels, in accordance with some embodiments;

FIG. 7 is a block diagram illustrating transitioning tasks between hierarchical timing wheels, in accordance with some embodiments; and

FIG. 8 illustrates a flowchart of an example method that can be carried out by a timeout management device, in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

In some examples, a system manages task state timeouts (e.g., in a micro services environment) using hierarchical timing wheels. The system may manage the task state timeouts across an entire application cluster, and across multiple nodes of a distributed computing network. The system may establish distributed hierarchical timing wheels for one or more state machines in one or more data repositories. For instance, the system may implement every timing wheel as a replicated ring buffer across a plurality of memory devices. Each timing wheel may correspond to a particular time range (e.g., period). For instance, a first timing wheel may correspond to a day (i.e., 24 hours), a second timing wheel may correspond to an hour (i.e., 60 minutes), and a third time wheel may correspond to a minute (i.e., 60 seconds).

Each timing wheel may have a number of task slots that corresponds to their particular time range. For instance, the first timing wheel corresponding to 24 hours may have 24 task slots. The second timing wheel corresponding to 60 minutes may have 60 slots. The third timing wheel corresponding to 60 seconds may have 60 task slots. Each timing wheel is incremented to a next slot based on their corresponding number of slots and particular time range (e.g., a tick value). For instance, each timing wheel may maintain a current slot pointer that identifies a current slot. The current slot pointer increments to a next slot once a corresponding amount of time (e.g., the tick value) expires. For instance, the current slot pointer of the first timing wheel may increment to a next slot every hour (e.g., tick value of an hour). The current slot pointer of the second timing wheel may be incremented to a next slot every minute (e.g., tick value of a minute). The current slot pointer of the third timing wheel may be incremented to a next slot every second (e.g., tick value of a second).

The system may allocate a task, such as a timeout task, to a slot of a timing wheel. For instance, an application may enter a first state. To transition to a second state, the application may need to receive one or more events (e.g., input events, such as receiving a message, an interrupt, a signal, or any other input event). A timeout task for the application may be allocated to a next available slot of one or more timing wheels. The timeout task for the application may be allocated to a timing wheel corresponding to a timeout for the timeout task. For example, if the timeout for the timeout task is an hour, the timeout task may be allocated to a slot of the 60 minute timing wheel.

The timeout task associated with a slot of a timing wheel may be executed if events required to proceed to a next state do not occur before the time range associated with the particular timing wheel expires. For instance, assuming a timeout task is placed in a first slot of the first time associated with 24 hours, the timeout task may be executed if 24 hours pass since the timeout task was associated with the slot without receiving required events to proceed to a next state. Alternatively, the timeout task may be removed from the corresponding timing wheel if the events required to proceed to a next state occur before the time range

As described herein, the system may establish an actor engine to handle updates to the distributed timing wheels. The actor engines may form a cluster across nodes running an application. In some examples, every timing wheel is assigned to a dedicated actor engine. All updates to the timing wheel are handled by dedicated actor engine. For instance, each dedicated actor engine is configured to add tasks to slots of the timing wheel. Each dedicated actor engine is also configured to remove tasks from slots, such as upon timeout expiration, upon state changes before timeout expiry, and during transfer of tasks to another timing wheel as described herein.

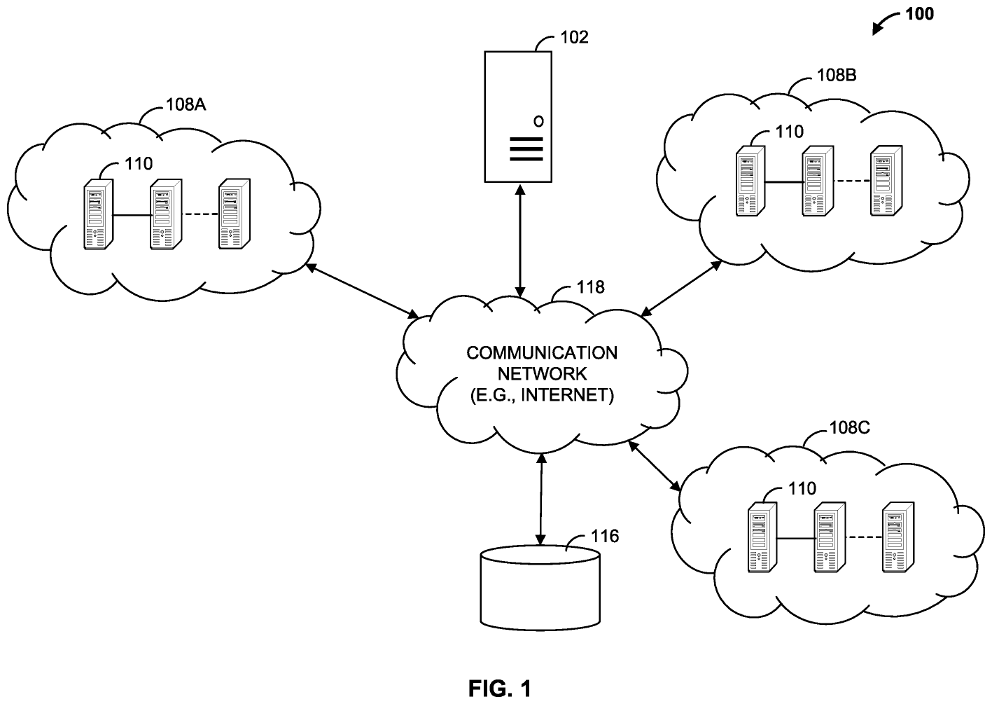

Turning to the drawings, FIG. 1 illustrates a block diagram of a task management system 100 that includes timeout management device 102, datacenters 108A, 108B, 108C, and a database 116 communicatively coupled over network 118. Datacenters 108A, 108B, 108C may be cloud-based datacenters, for example, and may include one or more compute nodes 110 (e.g., servers). Each compute node 110 may include, for example, processing resources, such as general processing units (GPUs) or central processing units (CPUs), as well as memory devices for storing digital data.

Timeout management device 102 and compute nodes 110 can each be any suitable computing device that includes any hardware or hardware and software combination that allow for the processing of data. For example, each of timeout management device 102 and compute nodes 110 can include one or more processors, one or more field-programmable gate arrays (FPGAs), one or more application-specific integrated circuits (ASICs), one or more state machines, digital circuitry, or any other suitable circuitry. Each of timeout management device 102 and compute nodes 110 can also include executable instructions stored in non-volatile memory that can be executed by one or more processors. For instance, any of timeout management device 102 and compute nodes 110 can be a computer, a workstation, a laptop, a server such as a cloud-based server, a web server, a smartphone, or any other suitable device. In addition, each of timeout management device 102 and compute nodes 110 can transmit data to, and receive data from, communication network 118.

Although FIG. 1 illustrates three datacenters 108A, 108B, 108C, task management system 100 can include any number of datacenters. Further, each datacenter 108A-108C can include any number of compute nodes 110. In some examples, the compute nodes 110 are organized by racks, where each rack includes one or more compute nodes 110. For example, each compute node 110 may be configured (e.g., by timeout management device 102) to operate as part of a particular rack. Further, task management system 100 can include any number of timeout management devices 102 and databases 116.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Each compute node 110 may execute one or more processing tasks, such as hypervisors that execute one or more virtual machines (VMs). For example, a compute node 110 may configure a hypervisor to execute one or more VMs. Each VM may be based on a virtual machine operating system, such as a Microsoft®, Linux®, Red Hat®, MacOS®, or any other VM operating system. Each hypervisor may run one or more of the same, or differing, VMs. Compute nodes 110 may be operable to obtain executable instructions from for example, non-volatile memory, and may execute the instructions to establish the one or more processing tasks, including the VMs. Each processing task may execute among one or more processing cores of a processor, such as a CPU, of a compute node 110. In some examples, a processing task may execute among one or more processors of a compute node 110, or among processors of multiple compute nodes 110.

Database 116 can be any suitable non-volatile memory, such as a remote storage device, a memory device of a cloud-based server, a memory device on another application server, a memory device of a networked computer, or any other suitable non-transitory data storage device. In some examples, database 116 can be a local storage device, such as a hard drive, a nonvolatile memory, or a USB stick. Database 116 may store datacenter network data such as compute node 110 status information, and may also store compute node 110 configuration data. For example, timeout management device 102 may obtain compute node 110 configuration data from database 116, and “push” the configuration data to one or more compute nodes 110 for install. Further, timeout management device 102 may assign one or more tasks, such as one or more tasks of an application, to one or more compute nodes 110 of one or more datacenters 108A, 108B, 108C.

Timeout management device 102 may also configure ring buffers as described herein within each of datacenters 108A, 108B, 108C. For instance, timeout management device 102 may transmit a ring buffer message to datacenter 108A to have a VM executed by a compute node 110 establish a ring buffer within memory for each of one or more timing wheels. For instance, the ring buffer message may identify a time period associated with the ring buffer to be established, such as a ring buffer for a timing wheel associated with a time period of 24 hours, 60 minutes, 60 seconds, or any other time range. In some examples, timeout management device 102 transmits a ring buffer message to a plurality of datacenters 108A, 108B, 108C to establish replicated ring buffers for each of one or more timing wheels. As described herein, a slot of a ring buffer may be associated with a timeout task. For instance, a slot may maintain a mapping of objects for a given task state to be timed out when the timeout for that slot expires. If a state transition takes effect before expiration of the timeout associated with a ring buffer, the objects may be removed from the slot. Otherwise, if the timeout expires, a timeout task may be executed by the corresponding datacenter 108A, 108B, 108C. As described herein, a current slot pointer points to a slot that may have objects whose states expire at timeout. For example, the dedicated actor engine may receive timer updates, and may determine when to increment the current slot pointer based on the timer updates. As further described herein, each ring buffer may be replicated (e.g., across datacenters 108A, 108B, 108C) to ensure fault tolerance.

Each timing wheel may also have a dedicated actor engine that manages the time wheel. The dedicated actor engines may form a cluster across nodes running a particular application. Each dedicated actor engine may allocate tasks (e.g., timeout tasks) to the slots of the timing wheel, and may deallocate (e.g., remove) tasks from the slots as well. In addition, because more than one VM (e.g., executing on any given compute node 110) may generate a timer update, timer updates may be queued and the corresponding actor engine may apply a Highest Value Wins Policy as described herein to increment the current slot pointer.

In some examples, actor engines are established based on a distributed hashing scheme, such as a Consistent Hashing routing strategy. For instance, hash tables can be maintained across multiple compute nodes 110 across one or more datacenters 108A, 108B, 108C. As such, memory limitations of a single compute node 110 are alleviated.

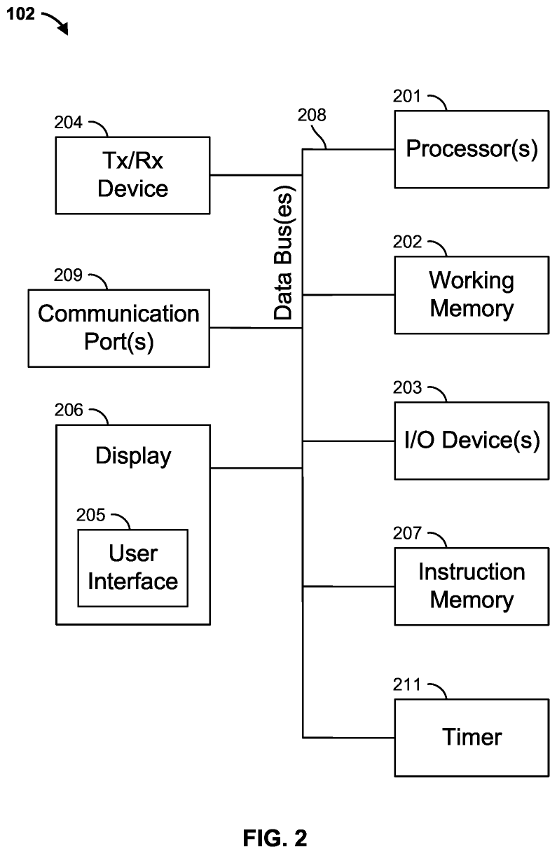

FIG. 2 illustrates the timeout management device 102 of FIG. 1. Timeout management device 102 can include one or more processors 201, working memory 202, one or more input/output devices 203, instruction memory 207, a transceiver 204, a display 206, one or more communication ports 209, and a timer 211 all operatively coupled to one or more data buses 208. Data buses 208 allow for communication among the various devices. Data buses 208 can include wired, or wireless, communication channels.

Processors 201 can include one or more distinct processors, each having one or more processing cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can be configured to perform a certain function or operation by executing the instructions stored on instruction memory 207 embodying the function or operation. For example, processors 201 can be configured to perform one or more of any function, method, or operation disclosed herein.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of timeout management device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions stored in instruction memory 207. In some examples, communication port(s) 209 allow for the transfer (e.g., uploading or downloading) of data, such as datacenter configuration files.

Display 206 can display user interface 205. User interfaces 205 can enable user interaction with timeout management device 102. For example, user interface 205 can be a user interface for an application of a retailer that allows a customer to initiate the return of an item to the retailer. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 timeout management device 102 will be operating in. Processor(s) 201 is operable to receive data from, or send data to, a network, such as communication network 118 of FIG. 1, via transceiver 204.

Timer 211 can be any suitable timer, and can provide time updates to processor 201. For example, timer 211 may receive time and date information over network 118, and may provide the time and data information as time updates to processor 201. In some examples, timer 211 maintains a date and a time of day (e.g., within one or more registers). In some examples, timer 211 synchronizes to a timestamp provided by the Global Positioning System (GPS), and provides the timestamp to processor 201.

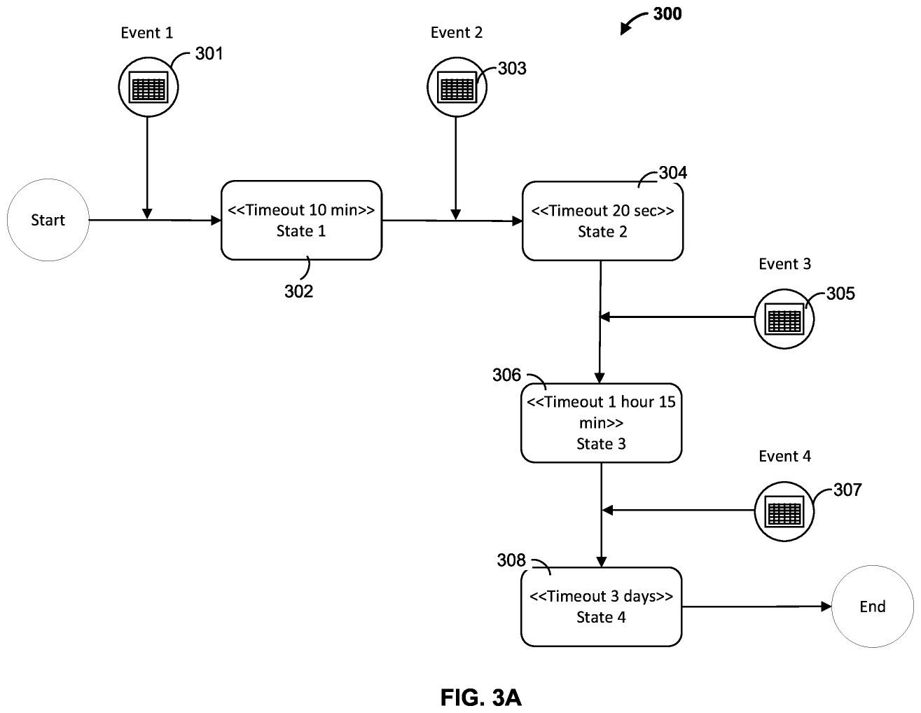

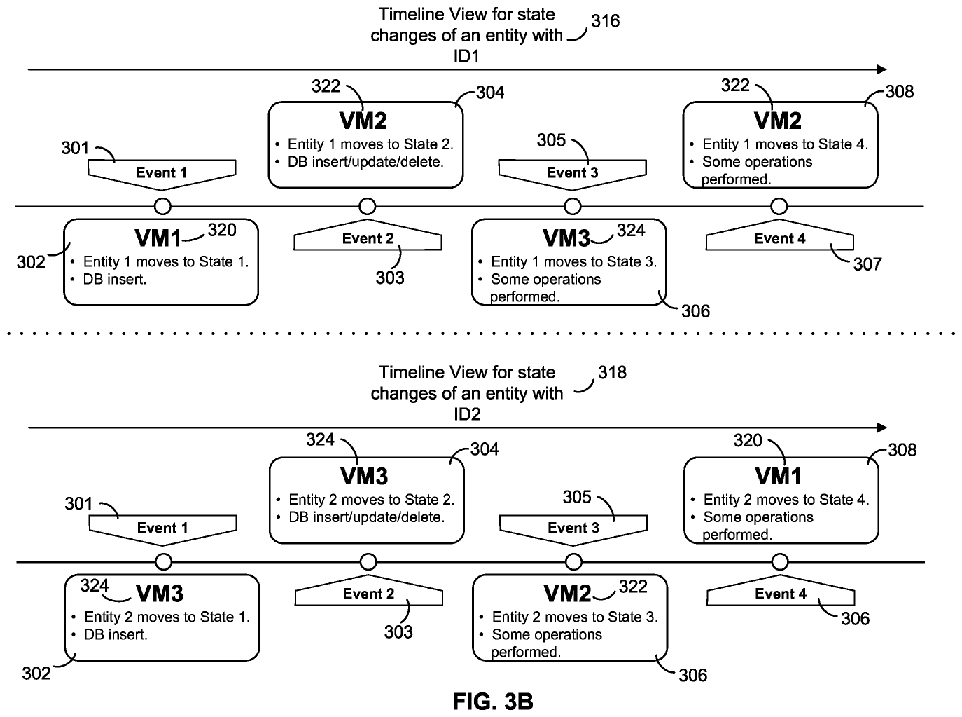

FIG. 3A is a block diagram of a state machine 300 that includes a first state 302, a second state 304, a third state 306, and a fourth state 308. First state 302 is associated with a task timeout of 10 minutes. Second state 304 is associated with a task timeout of 20 seconds. Moreover, third state 306 is associated with a task timeout of 1 hour and 15 minutes, and fourth state 308 is associated with a task timeout of 3 days. In this example, an entity (e.g., application) may move to the first state 302 upon the occurrence of a first event 301. Similarly, the entity may move from the first state 302 to the second state 304 upon the occurrence of a second event 303. If the second event 303 fails to occur within the timeout of 10 minutes associated with first state 302, the entity may exit the state machine 300.

From second state 304, the entity may move to third state 306 upon the occurrence of third event 305. If the third event 305 fails to occur within the timeout of 20 seconds associated with second state 304, the entity may exit the state machine 300. The entity may then move from third state 306 to fourth state 308 upon the occurrence of the fourth event 307. If the fourth event 307 fails to occur within the timeout of 1 hour and 15 minutes associated with third state 306, the entity may exit the state machine 300. Once processing is complete at the fourth state 308, the entity exits the state machine 300.

FIG. 3B, for instance, illustrates state changes for entities executing among various VMs, such as VMs executed by one or more compute nodes 110 of datacenters 108A, 108B, 108C. For instance, an entity with a first identification (ID) 316 may move to the first state 302 upon the occurrence of first event 301. The first state 302 may be executed by a first VM 320 (e.g., a compute node 110 of datacenter 108A). Upon the occurrence of second event 303, the entity moves to second state 304. The second state 304 is executed by a second VM 322 (e.g., a compute node 110 of datacenter 108B). Further, and upon occurrence of third event 305, the entity moves to third state 306. The third state 306 is executed by a third VM 324 (e.g., another compute node of datacenter 108B). Finally, and upon occurrence of fourth event 307, the entity moves to fourth state 308. The fourth state 308 is executed by the second VM 322.

Similarly, an entity with a second ID 318 may move to the first state 302 upon the occurrence of first event 301. The first state 302 may be executed by the third VM 324. Upon the occurrence of second event 303, the entity moves to second state 304. The second state 304 is also executed by the third VM 324. Further, and upon occurrence of third event 305, the entity moves to third state 306. The third state 306 is executed by the second VM 322. Finally, and upon occurrence of fourth event 307, the entity moves to fourth state 308. The fourth state 308 is executed by the first VM 320.

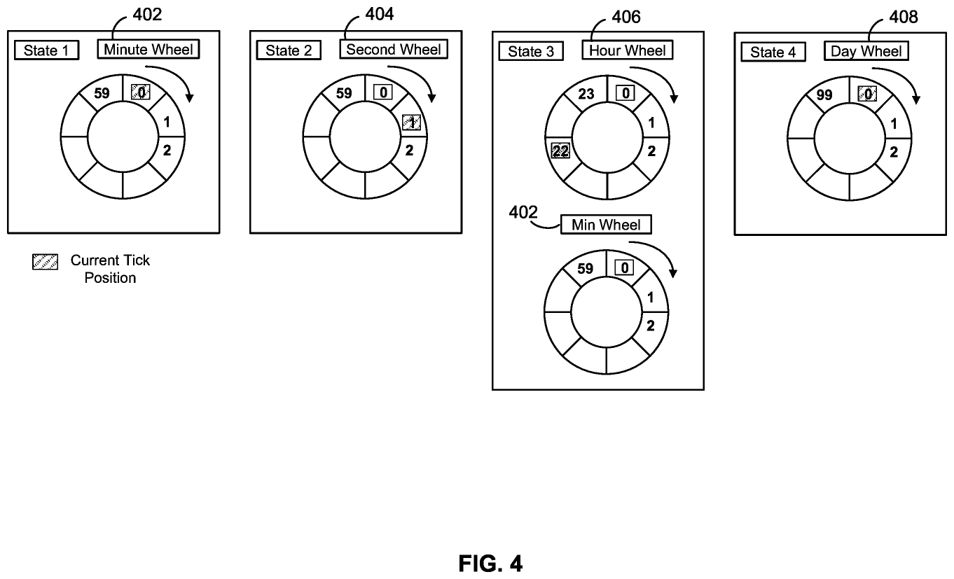

FIG. 4 is a block diagram illustrating exemplary hierarchical timing wheels 402, 404, 406, 408. Each of hierarchical timing wheels 402, 404, 406, 408 may be established as a replicated ring buffer across various memory devices. For example, hierarchical timing wheel 402 has a time range of 60 minutes (e.g., a minute wheel), and thus has 60 slots (e.g., numbered 0 through 59). A current tick point points to one slot, and advances to a next slot every minute. In this example, upon entering a first state of a state machine (e.g., state machine 300), a timeout task is allocated to a slot pointed to by the current tick pointer, i.e., a current tick position (in this example, position 0). Every minute, the current tick pointer is incremented to point to the next slot. If the next slot has a timeout task allocated to it, the timeout task may be executed and deallocated from the slot. A new timeout task may then be allocated to the slot, assuming one is received. As such, a timeout task can remain allocated to hierarchical timing wheel 402 for up to 60 minutes.

Hierarchical timing wheel 404 has a time range of 60 seconds (e.g., a second wheel), and thus has 60 slots (e.g., numbered 0 through 59). A current tick point points to one slot, and advances to a next slot every second. In this example, upon entering a second state of the state machine, a timeout task is allocated to a slot pointed to by the current tick pointer, i.e., a current tick position (in this example, position 1). Every second, the current tick pointer is incremented to point to the next slot. If the next slot has a timeout task allocated to it, the timeout task may be executed and deallocated from the slot. A new timeout task may then be allocated to the slot, assuming one is received. As such, a timeout task can remain allocated to hierarchical timing wheel 402 for up to 60 seconds.

Hierarchical timing wheel 406 has a time range of 24 hours (e.g., an hour wheel), and thus has 24 slots (e.g., numbered 0 through 23). A current tick point points to one slot, and advances to a next slot every hour. In this example, upon entering a third state of the state machine, a timeout task is allocated to a slot pointed to by the current tick pointer, i.e., a current tick position (in this example, position 22). Every hour, the current tick pointer is incremented to point to the next slot. If the next slot has a timeout task allocated to it, the timeout task may be executed and deallocated from the slot. A new timeout task may then be allocated to the slot, assuming one is received. As such, a timeout task can remain allocated to hierarchical timing wheel 406 for up to 24 hours.

Hierarchical timing wheel 408 has a time range of 100 days (e.g., a day wheel), and thus has 100 slots (e.g., numbered 0 through 99). A current tick point points to one slot, and advances to a next slot every 24 hours. In this example, upon entering a fourth state of the state machine, a timeout task is allocated to a slot pointed to by the current tick pointer, i.e., a current tick position (in this example, position 0). Every day, the current tick pointer is incremented to point to the next slot. If the next slot has a timeout task allocated to it, the timeout task may be executed and deallocated from the slot. A new timeout task may then be allocated to the slot, assuming one is received. As such, a timeout task can remain allocated to hierarchical timing wheel 408 for up to 100 days.

In some examples, and upon expiration of a timeout for a particular hierarchical timing wheel slot, a timeout task is deallocated from a slot of a current hierarchical timing wheel and allocated to a slot of another hierarchical timing wheel. For instance, assume a state of the state machine is associated with a timeout of 1 day and 1 hour. In other words, the state of the state machine will wait up to 1 day and 1 hour for one or more events to be received before the state is to time out. In this example, a timeout task associated with the state of the state machine may be allocated to a slot of hierarchical timing wheel 406 (e.g., the slot the current tick pointer for the hierarchical timing wheel 406 is pointing to). Assuming 24 hours expire and the one or more events are not received (e.g., the current tick pointer for the hierarchical timing wheel 406 is again pointing to the slot), the timeout task may be deallocated from the slot of hierarchical timing wheel 406, and allocated to a slot of hierarchical timing wheel 402 (e.g., the slot the current tick pointer for the hierarchical timing wheel 402 is pointing to). If the one or more events are not received within an hour, the timeout task may be deallocated from the slot and executed. In this manner tasks associated with varying timeouts can be assigned to multiple timing wheels over a corresponding timeout period. In some examples, a task may be allocated to a same timing wheel multiple times. For instance, with a timeout of five minutes, a task may be assigned to a minute timing wheel up to five times for a total of five minutes.

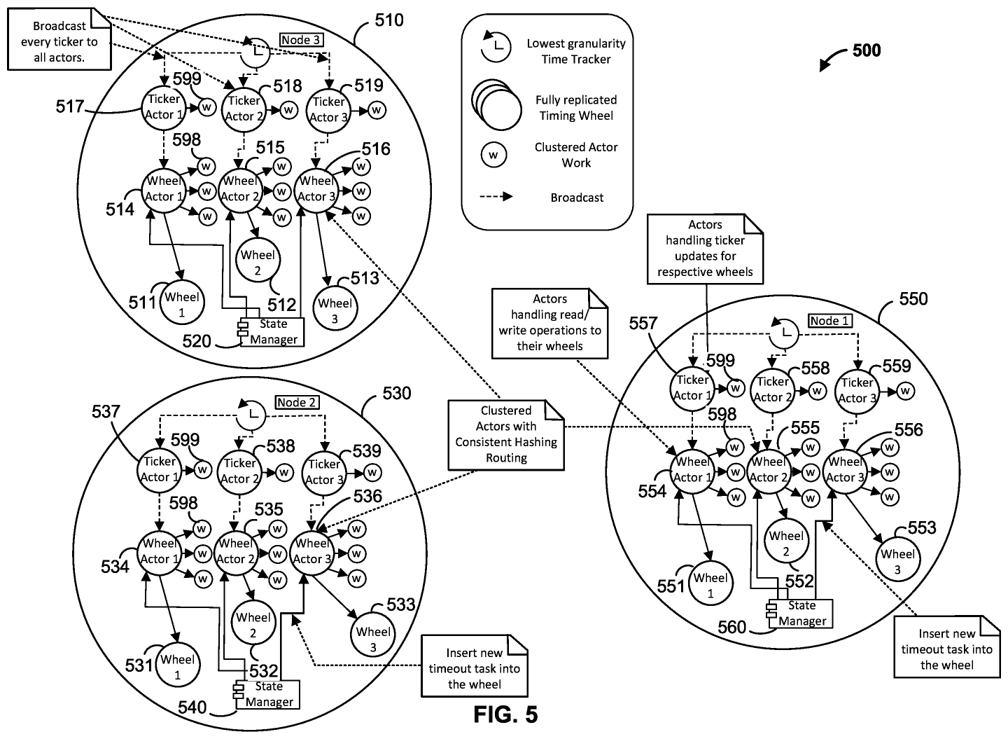

FIG. 5 illustrates a distributed system 500 with multiple compute nodes 510, 530, 550 employing hierarchical timing wheels and dedicated actor engines. For instance, compute nodes 510, 530, 550 may be any compute node 110 within any of datacenters 108A, 108B, 108C. First node 510 includes a first timing wheel 511, a second timing wheel 512, and a third timing wheel 513. Each of first timing wheel 511, second timing wheel 512, and third timing wheel 513 may be a ring buffer in memory and may correspond to a differing time granularity (e.g., 60 seconds, 60 minutes, 24 days, etc.). A state managing engine 520 can manage task state timeouts, such as for an application. The state managing engine 520 can receive requests to allocate tasks to, and deallocate tasks from, first timing wheel 511, second timing wheel 512, and third timing wheel 513.

For example, first actor engine 514 handles read and write operations to first timing wheel 511, such as by receiving, and acting upon, read and write requests from state managing engine 520. For instance, first actor engine 514 may receive a request to allocate one or more objects identifying a timeout task to a slot of first timing wheel 511 from state managing engine 520. First actor engine 514 may allocate the one or more objects to a current slot of first timing wheel 511 (e.g., the slot pointed to by a current slot pointer of first timing wheel 511). Similarly, a second actor engine 515 handles read and write operations to second timing wheel 512, and a third actor engine 516 handles read and write operations to third timing wheel 513. Each of first actor engine 514, second actor engine 515, and third actor engine 516 can include one or more actor workers 598 that can update, respectively, first timing wheel 511, second timing wheel 512, and third timing wheel 513. For instance, actor workers 598 can execute tasks, remove tasks, cancel tasks, and perform other operations with respect to their corresponding timing wheel.

A first ticker actor 517 handles timing updates (e.g., ticker updates) for first timing wheel 511. For instance, first ticker actor 517 may receive a time update from timer 211. Based on the time update, first ticker actor 517 may determine whether a current slot pointer of first timing wheel 511 is to be incremented. First ticker actor 517 may send a message to first actor engine 514 to increment the current slot pointer of first timing wheel 511 to a next slot when the time range associated with first timing wheel 511 has expired. For instance, assuming first timing wheel 511 is a minute wheel, first ticker actor 517 may determine whether a minute has passed since the current slot pointer was last incremented based on the time update. If the minute has passed, first ticker actor 517 may send the message to first actor engine 514 to increment the current slot pointer to the next slot. Similarly, second ticker actor 518 handles timing updates for second timing wheel 512, and third ticker actor 519 handles timing updates for third timing wheel 513. Each of first ticker actor 517, second ticker actor 518, and third ticker actor 519 can include one or more ticker workers 599 that can update, respectively, first timing wheel 511, second timing wheel 512, and third timing wheel 513. For instance, ticker workers 599 can update the current tick for their corresponding timing wheel.

Second node 530 includes a first timing wheel 531, a second timing wheel 532, and a third timing wheel 533. Each of first timing wheel 531, second timing wheel 532, and third timing wheel 533 may be a ring buffer in memory and may correspond to a differing time granularity (e.g., 60 seconds, 60 minutes, 24 days, etc.). A state managing engine 540 can manage task state timeouts, such as for an application. The state managing engine 540 can receive requests to allocate tasks to, and deallocate tasks from, first timing wheel 531, second timing wheel 532, and third timing wheel 533.

First actor engine 534 handles read and write operations to first timing wheel 531, such as by receiving, and acting upon, read and write requests from state managing engine 540. For instance, first actor engine 534 may receive a request to allocate one or more objects identifying a timeout task to a slot of first timing wheel 531 from state managing engine 540. First actor engine 534 may allocate the one or more objects to a current slot of first timing wheel 531 (e.g., the slot pointed to by a current slot pointer of first timing wheel 531). Similarly, a second actor engine 535 handles read and write operations to second timing wheel 532, and a third actor engine 536 handles read and write operations to third timing wheel 533. Each of first actor engine 534, second actor engine 535, and third actor engine 536 can include one or more actor workers 598 that can update, respectively, first timing wheel 531, second timing wheel 532, and third timing wheel 533.

A first ticker actor 537 handles timing updates (e.g., ticker updates) for first timing wheel 531. For instance, first ticker actor 537 may receive a time update from a timer 211. Based on the time update, first ticker actor 537 may determine whether a current slot pointer of first timing wheel 531 is to be incremented. First ticker actor 537 may send a message to first actor engine 534 to increment the current slot pointer of first timing wheel 531 to a next slot when the time range associated with first timing wheel 531 has expired. Similarly, second ticker actor 538 handles timing updates for second timing wheel 532, and third ticker actor 539 handles timing updates for third timing wheel 533. Each of first ticker actor 537, second ticker actor 538, and third ticker actor 539 can include one or more ticker workers 599 that can update, respectively, first timing wheel 531, second timing wheel 532, and third timing wheel 533.

Third node 550 includes a first timing wheel 551, a second timing wheel 552, and a third timing wheel 553. Each of first timing wheel 551, second timing wheel 552, and third timing wheel 553 may be a ring buffer in memory and may correspond to a differing time granularity (e.g., 60 seconds, 60 minutes, 24 days, etc.). A state managing engine 560 can manage task state timeouts, such as for an application. The state managing engine 560 can receive requests to allocate tasks to, and deallocate tasks from, first timing wheel 551, second timing wheel 552, and third timing wheel 553.

First actor engine 554 handles read and write operations to first timing wheel 551, such as by receiving, and acting upon, read and write requests from state managing engine 560. For instance, first actor engine 554 may receive a request to allocate one or more objects identifying a timeout task to a slot of first timing wheel 551 from state managing engine 560. First actor engine 554 may allocate the one or more objects to a current slot of first timing wheel 551 (e.g., the slot pointed to by a current slot pointer of first timing wheel 551). Similarly, a second actor engine 555 handles read and write operations to second timing wheel 552, and a third actor engine 556 handles read and write operations to third timing wheel 553. Each of first actor engine 554, second actor engine 555, and third actor engine 556 can include one or more actor workers 598 that can update, respectively, first timing wheel 551, second timing wheel 552, and third timing wheel 553.

A first ticker actor 557 handles timing updates (e.g., ticker updates) for first timing wheel 551. For instance, first ticker actor 557 may receive a time update from a timer 211. Based on the time update, first ticker actor 557 may determine whether a current slot pointer of first timing wheel 551 is to be incremented. First ticker actor 557 may send a message to first actor engine 554 to increment the current slot pointer of first timing wheel 551 to a next slot when the time range associated with first timing wheel 551 has expired. Similarly, second ticker actor 558 handles timing updates for second timing wheel 552, and third ticker actor 559 handles timing updates for third timing wheel 553. Each of first ticker actor 557, second ticker actor 558, and third ticker actor 559 can include one or more ticker workers 599 that can update, respectively, first timing wheel 551, second timing wheel 552, and third timing wheel 553.

Any of the actor engines, state managing engines, and ticker actors described herein may be implemented in hardware, or by the execution of instructions by one or more processors, such as by processor 201 executing instructions stored in instruction memory 207. In some examples, the timing wheels may be configured as ring buffers stored in a memory device accessible by a corresponding compute node, such as a VM executing on a compute node 110.

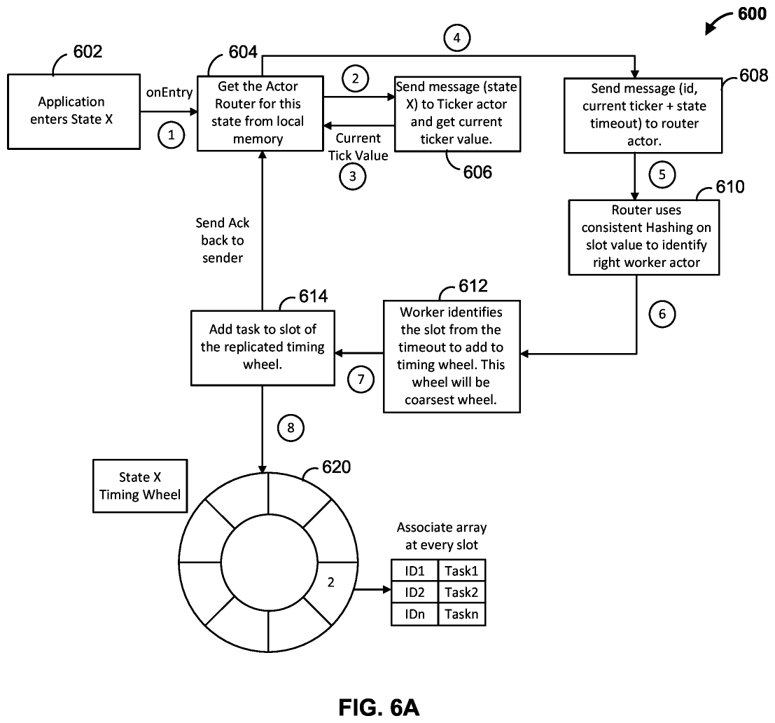

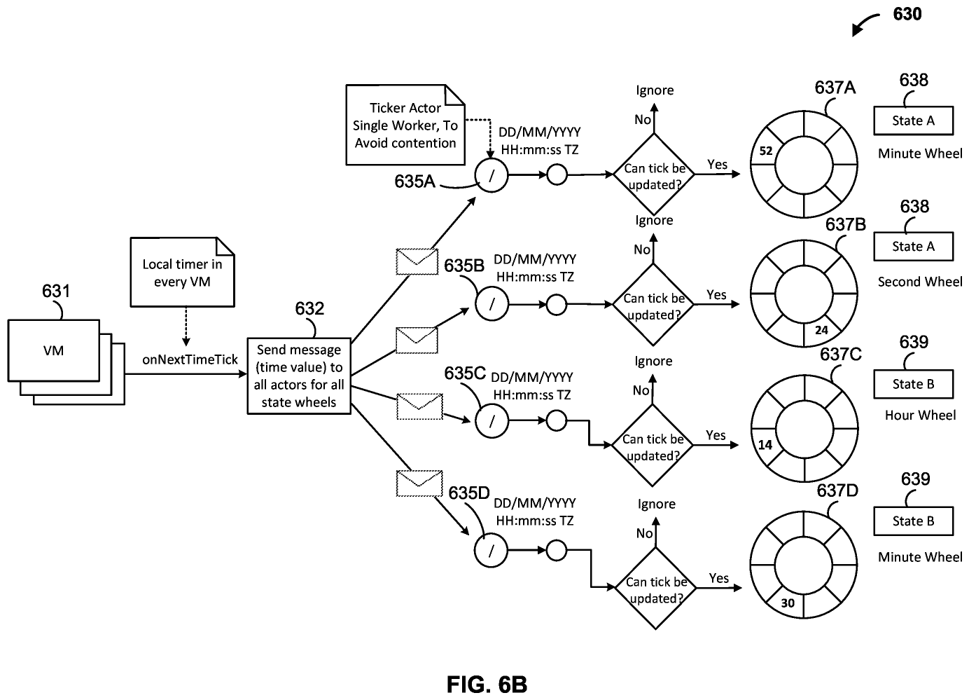

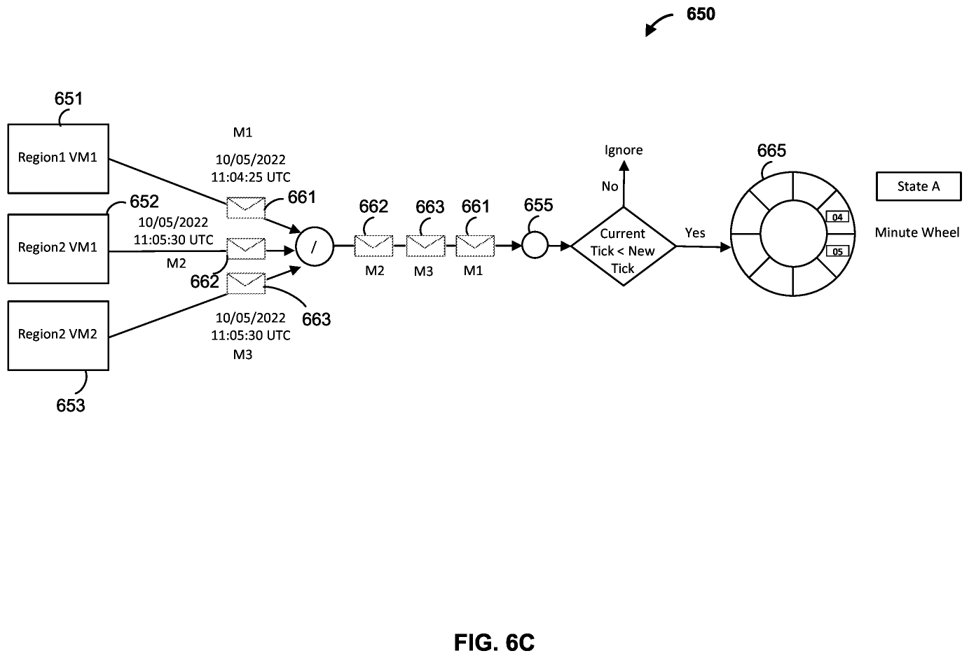

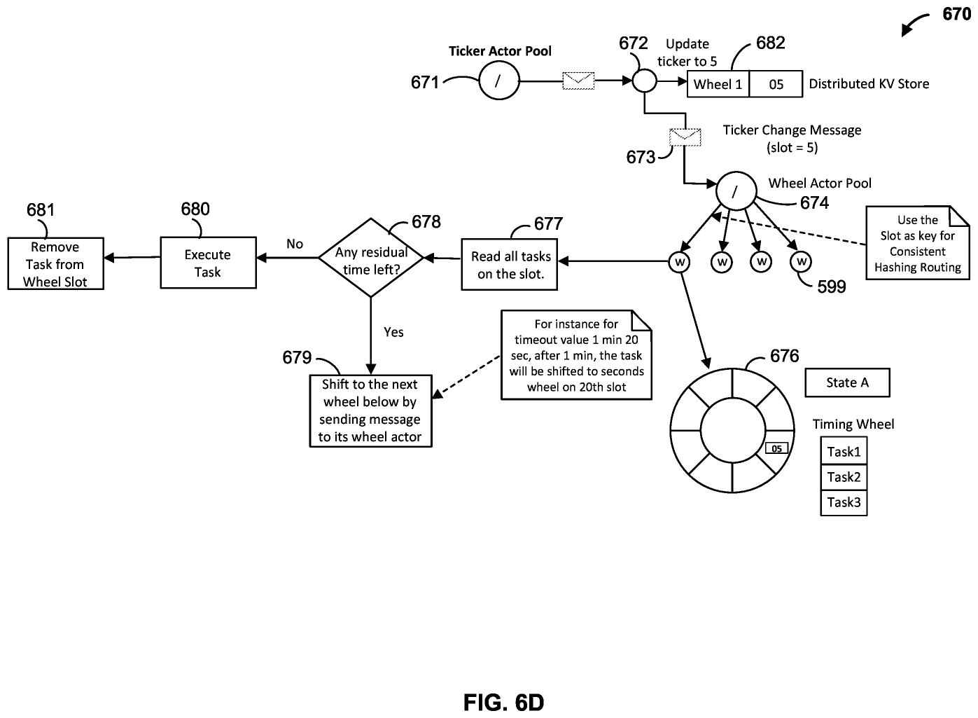

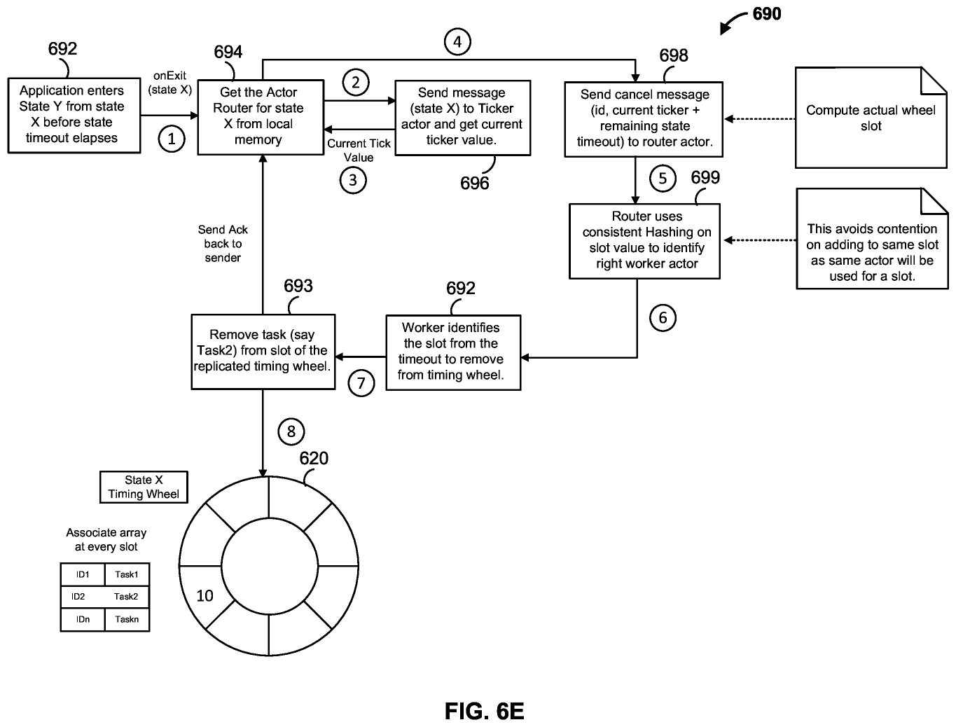

FIG. 6A illustrates a block diagram of a process 600 to add a new timeout task to a slot of a timing wheel. For example, at block 602, an application enters a state “X.” At block 604, an actor router, such as first actor engine 514, is established for state “X.” For example, the actor router for state “X” may be obtained from memory. At block 606, a message is sent to a corresponding ticker actor, such as ticker actor 517, to obtain a timer update (e.g., a timestamp, date, time, etc.). Further, at block 608, a message is sent to a router actor. The router actor may be, for example, another actor engine or another ticker actor. A router actor can route data, such as messages, based on various strategies including, for instance, round robin, consistent hash, random, custom, etc. The message may include an ID (e.g., a task ID), the timer update, and a state timeout value (e.g., 5 minutes). The router actor, at block 610, determines a slot value from the timer update. For instance, if the timer update is received as 10:55:20 in hh:mm:ss format, the router actor would compute the slot value as the 10th slot on an hour timing wheel, the 55th slot on a minute timing wheel, and the 20th slot on a seconds timing wheel. The router actor then applies a consistent hashing to a slot value to determine a worker actor, and routes the message to the worker actor.

At block 612, the worker actor identifies the slot to add to a timing wheel based on the state timeout value. For instance, if the state timeout value is 5 minutes, the worker actor may allocate a slot within a minute wheel. The worker actor may determine the coarsest timing wheel possible based on the state timeout value (e.g., the timing wheel with the longest time range without going over the state timeout value). The worker actor may send a message to a corresponding actor engine to add a timeout task associated with state “X” of the application to a slot of timing wheel 620. In some examples, the same worker actor is used to identify the slot of a timing wheel, thereby avoiding contention for access to the same slot of a timing wheel (e.g., if more than one entity where trying to access the slot). At block 614, the actor engine adds the task to the slot of the timing wheel 620. In some examples, the actor engine sends an acknowledgement (e.g., an “Ack”) to the application acknowledging the allocation of the task to the slot of the timing wheel 620.

FIG. 6B illustrates a block diagram of a process 630 to advance a current slot pointer of a timing wheel. At block 632, a VM 631 sends a time value (e.g., as obtained from a timer, such as a timer 211), to ticker actors 635A, 635B, 635C, 635D for corresponding timing wheels 637A, 637B, 637C, 637D. In some examples, timing wheels 637A and 637B are used for determining timeouts of a state “A” 638 of a state machine, and timing wheels 637C, 637D are used for determining timeouts of a state “B” 639 of the state machine.

Each ticker actor 635A, 635B, 635C, 635D determines, based on the time value, whether a current slot timer of the corresponding timing wheel 637A, 637B, 637C, 637D can be incremented. For instance, each ticker actor 635A, 635B, 635C, 635D determines whether the time range associated with the corresponding timing wheel 637A, 637B, 637C, 637D has passed since the current slot timer was last incremented. For example, if timing wheel 637A is a minute wheel, ticker actor 635A may determine whether a minute has passed since the current slot timer for that minute wheel was last incremented. If the ticker actor 635A, 635B, 635C, 635D determines that the corresponding time range has not expired, the time update is ignored (e.g., discarded). If, however, the ticker actor 635A, 635B, 635C, 635D determines that the corresponding time range has expired, the ticker actor 635A, 635B, 635C, 635D sends a message to the appropriate actor engine to have the current slot timer incremented. As discussed herein, once the current slot pointer is incremented, any task allocated to the slot pointed to by the current slot pointer is deallocated from the slot and executed.

FIG. 6C illustrates a block diagram of a process for handling time updates from multiple VMs. Among other advantages, the embodiments can handle clock skew among multiple timing updates from various timers (e.g., as received from various VMs). For instance, a first VM 651 may operate in a first region (e.g., a compute node 110 within datacenter 108A), a second VM 652 may operate in a second region (e.g., a compute node 110 within datacenter 108B), and a third VM 653 may operate in a third region (e.g., a same or different compute node 110 within datacenter 108B). Each of first VM 651, second VM 652, and third VM 653 may generate and transmit a message that includes a time value to a same ticker actor 655. For instance, first VM 651 may generate and transmit a first message 661 that includes a time value. Similarly, second VM 652 may generate and transmit a second message 662 that includes a time value, and third VM 653 may generate and transmit a third message 663 that includes a time value. Assume the ticker actor 655 receives the first message 661, followed by the third message 663, which is followed by the second message 662. Also assume that each of the first message 661, second message 662, and third message 663 have differing time values. Ticker actor 655 is configured to ignore time updates that are timestamped with a same or older time update than a time update already received.

For instance, assume the first message 661 identifies a time value that includes a time of 11:04:25 and a date of Oct. 5, 2022. Also assume that second message 662 identifies a time value that includes a time of 11:05:30 and the same date of Oct. 5, 2022, and third message 663 identifies a time value that includes a time of 11:05:30 and the same date of Oct. 5, 2022. On receiving first message 661, ticker actor 655 causes the current slot pointer of a timing wheel 665 to increment and point to slot 4. Upon receiving third message 663, ticker actor 655 causes the current slot pointer to increment and point to slot 5, as more than a minute has elapsed, according to the time value of third message 663 compared to the time value of first message 661. Further, and upon receiving second message 662, ticker actor 655 ignores the time update because the last one received (i.e., third message 663) indicated the same date and time as the time value of second message 662.

FIG. 6D is a block diagram of a process 670 for executing tasks, such as timeout tasks, on timeout. For example, a VM (e.g., executed by a compute node 110, timeout management device 102) may establish a ticker actor 672 from a ticker actor pool 671 to update one or more timing wheels, such as timing wheel 682. For instance, upon receiving a time update (e.g., from a timer 211), ticker actor 672 may determine whether to cause the current slot pointer of timing wheel 682 to increment. If ticker actor 672 determines, based on the time update, that at least an amount of time greater than the time range of timing wheel 682 has passed since the last increment of the current slot pointer, ticker actor 672 may increment the current slot pointer of timing wheel 682. For instance, ticker actor 672 may change a value in memory representing the current slot pointed to by the current slot pointer, such as by incrementing the value by one.

Further, in some examples, ticker actor 672 may also determine if a current slot pointer of another timing wheel, such as timing wheel 676, is to be incremented based on the received time update. If ticker actor 672 determines that the current slot pointer of timing wheel 676 is to be incremented, ticker actor 672 may generate a time update message 673 that indicates one or more of a slot to update to (e.g., slot 5) and an indication to increment a current slot pointer (e.g., value of “1” indicates increment).

In some examples, the time update message 673 indicates a type of timing wheel to increment (e.g., a minute wheel, an hour wheel, a day wheel, etc.). For instance, the time update message 673 may include a value for each type of wheel, where one value indicates increment (e.g., “1”), and another value indicates not to increment (e.g., “0”). Ticker actor 672 may transmit the time update message 673 to wheel actor pool 674, which may instantiate and communicate with one or more ticker workers 599. Based on the time update message 673, the wheel actor pool 674 may determine a slot (e.g., slot number) to which each current slot pointer of each timing wheel is to be incremented to. The wheel actor pool 674 may further determine a ticker worker 599 associated with each timing wheel based on the slot. For instance, wheel actor pool 674 may use the slot as a key for consistent hashing routing to determine the ticker worker 599 for each timing wheel, such as timing wheel 676. Actor engine pool 674 may send a message to each corresponding ticker worker 599 to increment the current slot pointer of their associated timing wheels, such as timing wheel 676.

Once the current slot pointer is incremented, at block 677, ticker worker 599 may determine all tasks currently associated with the current slot (i.e., the slot pointed to by the current slot pointer). Further, and at block 678, the ticker worker 599 may determine whether any residual time is left based on the timeout associated with each task. For instance, for a given timeout task associated with the slot, the slot may hold (e.g., in memory) one or more objects characterizing a task ID, a pointer to the executable timeout task, and a timeout value associated with the timeout task. Ticker worker 599 may read the timeout value and determine whether the timeout associated with timing wheel 676 satisfies the full duration of timeout identified by the timeout value. For instance, if timing wheel is an hour wheel, ticker worker 599 may determine whether the timeout value is an hour, or more than an hour. If the timeout value is more than an hour, the ticker worker 599 determines that there is residual time left for the timeout task.

If there is residual time left, the ticker worker 599, at block 679, determines another timing wheel to which to allocate the task to, and generates a message to the action engine responsible for the determined timing wheel. The message may include, for example, the one or more objects characterizing the task ID, the pointer to the executable timeout task, and the timeout value. The ticker worker 599 may deallocate (e.g., remove) the task from the timing wheel 676 slot, and may transmit the message to the action engine responsible for the determined timing wheel. Otherwise, if there is no residual time left at block 678, the task is executed at block 680 (e.g., by the corresponding VM). Further, and at block 681, the ticker worker 599 deallocates the task from the timing wheel 676 slot.

FIG. 6E is a block diagram of a process 690 to deallocate a timeout task from a timing wheel (e.g., cancel the timeout task). At block 692, an application enters a state “Y” from a state “X” (e.g., the state “X” of FIG. 6A) before a timeout of state “X.” At block 694, an actor router (e.g., first actor engine 514) for state “X” is obtained from memory. At block 696, a message is sent to a corresponding ticker actor, such as ticker actor 517, to obtain a timer update (e.g., a timestamp, date, time, etc.). Further, at block 698, a cancel message is sent to another router actor (e.g., first actor engine 534) that includes an ID (e.g., a task ID), the timer update, and a remaining state timeout value (e.g., an amount of time remaining before the state times out). The router actor may determine the remaining state timeout value based on the timer update and the timeout value for the timeout task (e.g., by subtracting the timeout value from the timer update value).

Further, at block 699, the router actor determines a slot value (e.g., based on the received timer update), and applies a consistent hashing to the slot value to determine a worker actor, and routes the message to the worker actor. At block 692, the worker actor identifies the slot of the timing wheel from which to remove the task from. The worker actor may send a message to a corresponding actor engine to remove the timeout task associated with state “X” of the application from the slot of timing wheel 620. At block 693, the actor engine removes the task from the slot of the timing wheel 620. In some examples, the actor engine sends an acknowledgement to the application acknowledging the removal of the task from the slot of the timing wheel 620.

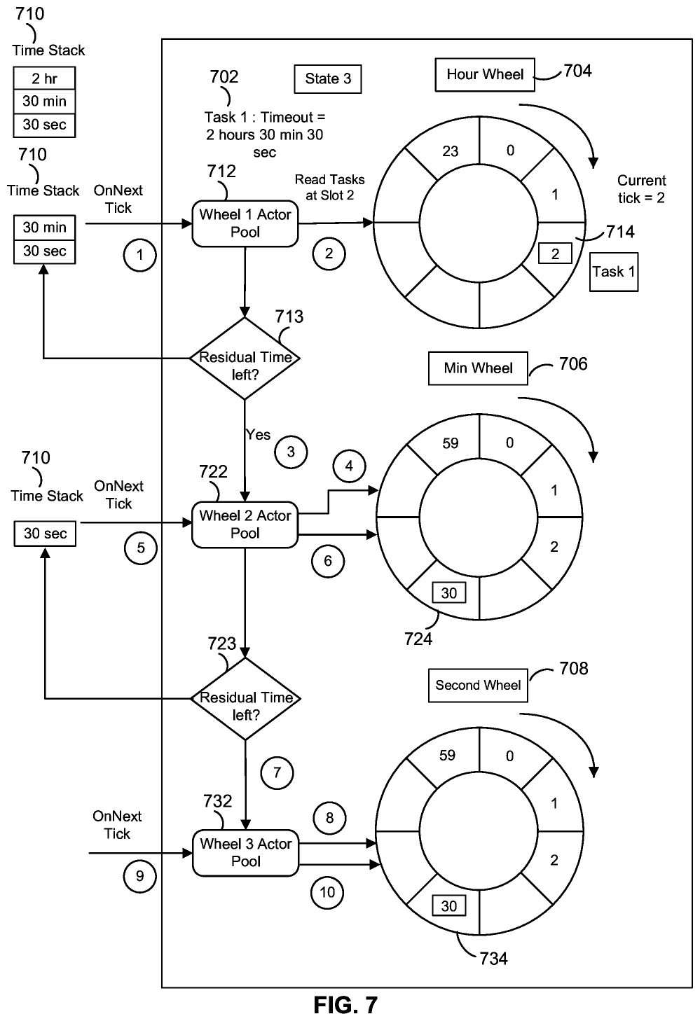

FIG. 7 illustrates a block diagram of a process to transfer a task 702 between hierarchical timing wheels 704, 706, 708. In this example, hierarchical timing wheel 704 is an hour timing wheel (e.g., the timing wheel is incremented to a next slot every hour), hierarchical timing wheel 706 is a minute timing wheel (e.g., the timing wheel is incremented to a next slot every minute), and hierarchical timing wheel 708 is a second timing wheel (e.g., the timing wheel is incremented to a next slot every second). As described herein each of hierarchical timing wheels 704, 706, 708 can be implement as ring buffers within a memory device (e.g., RAM, ROM, SRAM, etc.). In some examples, each ring buffer includes a predefined amount of memory for each slot, as well as a memory location identifying a current slot (e.g., the current slot pointed to by a current slot pointer of the ring buffer).

Task 702 is associated with a timeout of 2 hours, 30 minutes, and 30 seconds. timeout management device 102 generates a time stack 710 within memory, which breaks down the timeout into the various time granularities, and individually identifies the 2 hours, the 30 minutes, and the 30 seconds. A first wheel actor pool 712 allocates the task 702 to a slot 714 of the hour wheel 704. Because the hour wheel 704 has 24 slots and thus takes 24 hours for its current slot pointer to point to a same slot, the first wheel actor pool 712 allocates the task 702 to a slot 714 that is two slots from the slot pointed to by the current slot pointer.

Once the hour wheel 704 increments its current slot pointer to slot 714 (e.g., based on tick updates), the first wheel actor pool 712 reads the task allocated to slot 714, and updates the time stack 710 to remove the 2 hour time period. Further, at block 713, the first wheel actor 712 determines whether there is any residual time left. In this example, first wheel actor pool 712 determines, based on the time stack 710, that there is residual time left, and generates and transmits a message to second wheel actor pool 722 that identifies task 702, i.e., the task to be transferred.

Second wheel actor pool 722 determines, based on time stack 710, that the highest granularity for the time period is 30 minutes, and allocates the task to a slot 724 of minute wheel 706 that has 30 minutes remaining before it times out. Once the minute wheel 706 increments its current slot pointer to slot 724 (e.g., based on tick updates), the second wheel actor pool 722 reads the task allocated to slot 724, and updates the time stack 710 to remove the 30 minute time period. Further, at block 723, the second wheel actor 722 determines whether there is any residual time left. In this example, second wheel actor pool 722 determines, based on the time stack 710, that there is residual time left, and generates and transmits a message to third wheel actor pool 732 that identifies task 702, i.e., the task to be transferred.

Third wheel actor pool 732 determines, based on time stack 710, that the highest granularity for the time period is 30 seconds, and allocates the task to a slot 734 of second wheel 708 that has 30 seconds remaining before it times out. Once the second wheel 708 increments its current slot pointer to slot 734 (e.g., based on tick updates), the third wheel actor pool 722 reads the task allocated to slot 734, and updates the time stack 710 to remove the 30 second time period. In this example, because the full time for the task 702 expired (i.e., 2 hours, 30 minutes, and 30 seconds), the task 702 may be executed, as described herein.

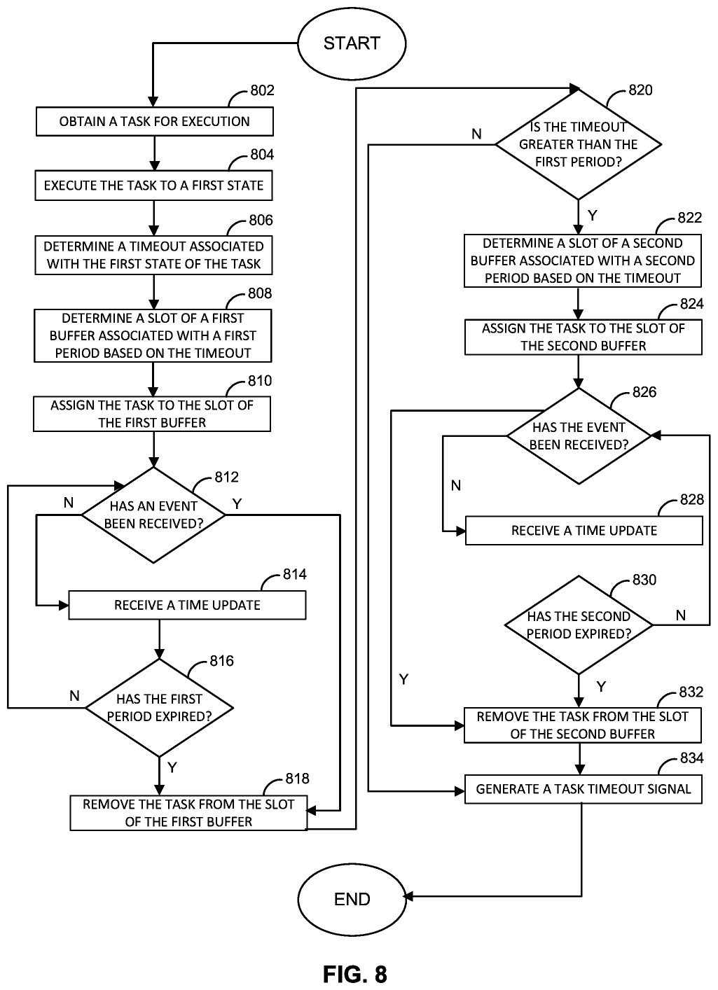

FIG. 8 illustrates a flowchart 800 of a method that may be performed by a computing device, such as a compute node 110 or timeout management device 102. Beginning at step 802, the computing device may obtain a task for execution and, at step 804, execute the task to a first state. Further, and at step 806, the computing device may determine a timeout associated with the first state of the task. At step 808, the computing device may determine a slot of a first buffer associated with a first period based on the timeout. For instance, the first buffer may be an hour wheel associated with 24 hours. The computing device may determine the slot of the first buffer based on the determined timeout. For instance, assuming the timeout is 2 hours and 30 minutes, the computing device may determine a slot of the first buffer that has 2 hours remaining before reaching time out. The method proceeds to step 810 where the computing device may assign the task to the slot of the first buffer.

At step 812, the computing device may determine whether an event has been received. For instance, the computing device may determine whether an event expected by the first state has been received. If the event has been received, the method proceeds to step 818, where the task is removed from the slot of the first buffer. Otherwise, if the event has not been received, the method proceeds to step 814.

At step 814, the computing device receives a time update. For instance, the computing device may receive a time update from a timer 211. At step 816, the computing device determines whether the first period has expired. If the first period has not expired, the method proceeds back to step 812 to determine whether the event has been received. Otherwise, if the first period has expired, the method proceeds to step 820.

At step 820, the computing device determines whether the timeout is greater than the first period. For instance, the computing device may subtract the first period (e.g., an hour) from the timeout (e.g., 2 hours, 30 minutes, and 30 seconds), and determine whether the difference is greater than zero. If the timeout is not greater than the first period (e.g., timeout expired), the method proceeds to step 834, where a task timeout signal is generated. In some examples, and based on the task timeout signal, the task is executed. If the timeout is greater than the first period, the method proceeds to step 822.

At step 822, the computing device determines a slot of a second buffer associated with a second period based on the timeout. For instance, the second buffer may be a minute wheel associated with 60 minutes. The computing device may determine the slot of the second buffer based on the determined timeout. For instance, assuming the timeout of 2 hours and 30 minutes, the computing device may determine a slot of the second buffer that has 30 minutes remaining before reaching time out. At step 824, the computing device may assign the task to the slot of the second buffer.

At step 826 the computing device determines whether the event has been received. If the event has been received, the method proceeds to step 832, where the task is removed from the slot of the second buffer. Otherwise, if the event has not been received, the method proceeds to step 828. At step 828, the computing device receives a time update.

Proceeding to step 830, the computing device determines whether the second period has expired. If the second period has not expired, the method proceeds back to step 826 to determine whether the event has been received. Otherwise, if the second period has expired, the method proceeds to step 832, where the computing device removes the task from the slot of the second buffer. From step 832, the method proceeds to step 834, where the task timeout signal is generated. The method then ends.

Among other advantages, the embodiments described herein can provide a reliable and scalable way of processing state timeouts. The embodiments can enable systems to be self-healing and proactive, as opposed to reactive, capabilities in the event of event failures, such as a failure to receive an input from an external systems expected by a state of a state machine. Further, the embodiments can enable distributed systems to take actions when entities, such as applications, become “stuck” in a certain state, thereby improving customer experience and reducing business and operational impacts. In addition, the embodiments can avoid dependence on an external scheduling system to trigger timeouts, which may be subject to failures themselves. For instance, the embodiments may handle timeouts despite the failure of one or more VMs going down and time update failures. The embodiments further allow for the execution of a timeout task through multiple supervised actors, and can avoid clock skew issues in VMs across datacenters. Persons of ordinary skill in the art may recognize additional benefits as well.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a non-transitory computer-readable memory having instructions stored thereon; and
a processor configured to read the instructions to:
obtain a task for execution;
determine a timeout associated with a first state of the task;
allocate a timeout task associated with the first state to one of a plurality of slots of a first timing wheel based on the timeout, wherein each of the plurality of slots of the first timing wheel corresponds to an increment of a first period; and
when the increment corresponding to the one of the plurality of slots of the first timing wheel expires before an event associated with the first state has been received:
deallocate the timeout task from the one of the plurality of slots of the first timing wheel;
determine a residual time based on the timeout and the increment corresponding to the one of the plurality of slots of the first timing wheel; and
allocate the timeout task associated with the first state to one of a plurality of slots of a second timing wheel based on the residual time, wherein each of the plurality of slots of the second timing wheel corresponds to an increment of a second period.

2. The system of claim 1, wherein, when the event associated with the first state has been received before the increment corresponding to the one of the plurality of slots of the first timing wheel expires, the processor is configured to:
deallocate the timeout task from the one of the plurality of slots of the first timing wheel; and
transition the task to a second state.

3. The system of claim 2, wherein the first state is implemented by a first virtual machine and the second state is implemented by a second virtual machine.

4. The system of claim 1, wherein the timeout is stored in the non-transitory computer-readable memory as a time stack having a first granularity value corresponding to the first period and a second granularity value corresponding to the second period.

5. The system of claim 4, wherein the processor is configured to update the time stack to remove the first granularity value when the increment corresponding to the one of the plurality of slots of the first timing wheel expires before the event associated with the first state has been received.

6. The system of claim 1, wherein the first timing wheel comprises a ring buffer distributed across two or more memory elements.

7. The system of claim 1, wherein the processor is configured to implement a dedicated actor for the first timing wheel, wherein the dedicated actor is configured to allocate or deallocate tasks to the first timing wheel.

8. The system of claim 7, wherein the processor is configured to implement a dedicated ticker actor for the first period, wherein the dedicated ticker actor for the first period is configured to cause the first timing wheel to increment a current slot location when the first period expires.

9. The system of claim 1, wherein when the increment corresponding to the one of the plurality of slots of the second timing wheel expires before the event associated with the first state has been received, the processor is configured to execute the timeout task.

10. A computer-implemented method comprising:
obtaining a task for execution;
determining a timeout associated with a first state of the task;
allocating a timeout task associated with the first state to one of a plurality of slots of a first timing wheel based on the timeout, wherein each of the plurality of slots of the first timing wheel corresponds to an increment of a first period;
when the increment corresponding to the one of the plurality of slots of the first timing wheel expires before an event associated with the first state has been received:
deallocating the timeout task from the one of the plurality of slots of the first timing wheel;
determining a residual time based on the timeout and the increment corresponding to the one of the plurality of slots of the first timing wheel; and
allocating the timeout task associated with the first state to one of a plurality of slots of a second timing wheel based on the residual time, wherein each of the plurality of slots of the second timing wheel corresponds to an increment of a second period; and
when the event associated with the first state has been received before the increment corresponding to the one of the plurality of slots of the first timing wheel expires:
deallocating the timeout task from the one of the plurality of slots of the first timing wheel; and
transitioning the task to a second state.

11. The computer-implemented method of claim 10, wherein the first state is implemented by a first virtual machine and the second state is implemented by a second virtual machine.

12. The computer-implemented method of claim 10, comprising storing the timeout in non-transitory computer-readable memory as a time stack having a first granularity value corresponding to the first period and a second granularity value corresponding to the second period.

13. The computer-implemented method of claim 12, comprising updating the time stack to remove the first granularity value when the increment corresponding to the one of the plurality of slots of the first timing wheel expires before the event associated with the first state has been received.

14. The computer-implemented method of claim 10, wherein the first timing wheel comprises a ring buffer distributed across two or more memory elements.

15. The computer-implemented method of claim 10, comprising implementing a dedicated actor for the first timing wheel, wherein the dedicated actor is configured to allocate or deallocate tasks to the first timing wheel.

16. The computer-implemented method of claim 15, comprising implementing a dedicated ticker actor for the first period, wherein the dedicated ticker actor for the first period is configured to cause the first timing wheel to increment a current slot location when the first period expires.

17. The computer-implemented method of claim 10, comprising executing the timeout task when the increment corresponding to the one of the plurality of slots of the second timing wheel expires before the event associated with the first state has been received.

18. A non-transitory computer readable medium having instructions stored thereon, wherein the instructions, when executed by at least one processor, cause a device to perform operations comprising:
obtaining a task for execution;
determining a timeout associated with a first state of the task;
storing the timeout in non-transitory computer-readable memory as a time stack having a first granularity value corresponding to a first period and a second granularity value corresponding to a second period allocating a timeout task associated with the first state to one of a plurality of slots of a first timing wheel based on the timeout, wherein each of the plurality of slots of the first timing wheel corresponds to an increment of the first period; and
when the increment corresponding to the one of the plurality of slots of the first timing wheel expires before an event associated with the first state has been received:
deallocating the timeout task from the one of the plurality of slots of the first timing wheel;
determining a residual time based on the timeout and the increment corresponding to the one of the plurality of slots of the first timing wheel;
updating the time stack to remove the first granularity value when the increment corresponding to the one of the plurality of slots of the first timing wheel expires before the event associated with the first state has been received; and
allocating the timeout task associated with the first state to one of a plurality of slots of a second timing wheel based on the residual time, wherein each of the plurality of slots of the second timing wheel corresponds to an increment of the second period.

19. The non-transitory computer readable medium of claim 18, wherein the instructions cause the device to perform operations comprising:
executing the timeout task when the increment corresponding to the one of the plurality of slots of the second timing wheel expires before the event associated with the first state has been received; and
transitioning the task to a second state when the event associated with the first state has been received before the increment corresponding to the one of the plurality of slots of the first timing wheel expires.

20. The non-transitory computer readable medium of claim 18, wherein the first timing wheel comprises a ring buffer distributed across two or more memory elements.
